(19) United States
(12) Patent Application Publication
(10) Pub. No.: US 2008/0218301 A1
(43) Pub. Date: Sep. 11, 2008

(54) MULTILAYER COIL COMPONENT AND METHOD OF MANUFACTURING THE SAME

(75) Inventor: Koichi Yamaguchi, Yoshida-gun (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/127,078

(22) Filed: May 27, 2008

Related U.S. Application Data
(63) Continuation of application No. PCT/JP2007/057874, filed on Apr. 10, 2007.

(30) Foreign Application Priority Data
Aug. 7, 2006 (JP) 2006-214862

(51) Int. Cl. H01F 27/02

(52) U.S. Cl. 336/83

(57) ABSTRACT

A multilayer coil component includes a coil formed by stacking first ceramic sheets in which coil conductor patterns are provided and a second ceramic sheet having a lower magnetic permeability than the first ceramic sheets, the coil conductor patterns being connected to each other. The second ceramic sheet is disposed between the first ceramic sheets. In a main surface of the second ceramic sheet, holes or recesses are provided. The first ceramic sheets adjacent to the second ceramic sheet are in contact with inner peripheral surfaces of the holes.

### BACKGROUND OF THE INVENTION

1. Field of the Invention

The present invention relates to multilayer coil components. More specifically, the present invention relates to a multilayer coil component including a coil formed by stacking magnetic layers and a low-magnetic-permeability layer, the magnetic layers having coil conductors provided therein, the low-magnetic-permeability layer having a lower magnetic permeability than the magnetic layers, and the coil conductors being electrically connected to each other, and to a method of manufacturing the same.

2. Description of the Related Art

Multilayer coil components can be classified into closed-magnetic-circuit multilayer coil components and open-magnetic-circuit multilayer coil components. The closed-magnetic-circuit multilayer coil components have an advantage in that a magnetic circuit having a high magnetic permeability and a low magnetic resistance is formed so that a high inductance can be achieved. At the same time, however, in the closed-magnetic-circuit multilayer coil components, since a large magnetic flux density arises, magnetic saturation tends to occur even if a superposed direct current is relatively small, so that a reduction of inductance due to magnetic saturation tends to occur. Therefore, the closed-magnetic-circuit multilayer coil components have a disadvantage in that DC superposing characteristics are poor.

A multilayer coil component which overcomes the disadvantage while maintaining the advantage is an open-magnetic-circuit multilayer coil component including coil conductor patterns extending around a magnetic member and sequentially connected in a stacking direction, wherein an insulating layer having a low magnetic permeability is provided so as to traverse a magnetic circuit formed around the coil conductor patterns (see, for example, Japanese Unexamined Utility Model Application Publication No. 63-87809). In this multilayer coil component, the insulating layer having the low magnetic permeability is provided in a region inside or outside the coil conductor patterns. In the region where the insulating layer having the low magnetic permeability is provided, the occurrence of magnetic saturation caused by an excessive magnetic flux density is suppressed. This suppresses a reduction of inductance due to magnetic saturation, so that DC superposing characteristics are improved. Furthermore, since the insulating layer is not provided over the entire surface, but is only provided on a portion of the surface, it is possible to achieve a relatively high magnetic permeability, so that a high inductance can be maintained.

However, since the adhesion between a layer having a high magnetic permeability and a layer having a low magnetic permeability is poor and these layers tend to be detached from each other, according to the multilayer coil component described in Japanese Unexamined Utility Model Application Publication No. 63-87809, cracks or delamination occur between an insulating layer having a low magnetic permeability and an insulating layer having a high magnetic permeability.

### SUMMARY OF THE INVENTION

To overcome the problems described above, preferred embodiments of the present invention provide an open-magnetic-circuit multilayer coil component in which cracks or delamination between layers having different magnetic permeabilities does not occur, and a method of manufacturing the same.

According to a preferred embodiment of the present invention, a multilayer coil component includes a coil formed by stacking magnetic layers and a low-magnetic-permeability layer, the magnetic layers having coil conductors provided therein, the low-magnetic-permeability layer having a lower magnetic permeability than the magnetic layers, and the coil conductors being electrically connected to each other, the low-magnetic-permeability layer is disposed between the magnetic layers, holes or recesses are provided in a main surface of the low-magnetic-permeability layer, and the magnetic layers adjacent to the low-magnetic-permeability layer are in contact with inner peripheral surfaces of the holes or the recesses. Since the magnetic layers adjacent to the low-magnetic-permeability layer are in contact with the inner peripheral surfaces of the holes or the recesses, an anchoring effect is provided between the magnetic layers and the low-magnetic-permeability layer. As a result, the occurrence of cracks or delamination between the magnetic layers and the low-magnetic-permeability layer is suppressed.

In the multilayer coil component according to this preferred embodiment of the present invention, the low-magnetic-permeability layer may have a coil conductor provided therein.

Preferably, side surfaces that define the inner peripheral surfaces of the holes or the recesses are continuously connected to each other. If the side surfaces that define the recesses or the holes are disconnected from each other, the magnetic layers and the low-magnetic-permeability layer do not contact each other at the disconnected portions. As a result, the anchoring effect provided between the magnetic layers and the low-magnetic-permeability layer is reduced. Therefore, in order to achieve an increased anchoring effect, preferably, the side surfaces that define the inner peripheral surfaces of the holes or the recesses are continuously connected to each other.

Preferably, the holes or the recesses are provided in regions outside the coil when viewed in a stacking direction. Furthermore, preferably, the holes or the recesses are provided in the proximity of a periphery of the low-magnetic-permeability layer. At the holes or the recesses, magnetic resistance is less than in the low-magnetic-permeability layer around the holes or the recesses. By providing such regions of low magnetic resistance outside the coil or in the proximity of the periphery of the low-magnetic-permeability layer, as compared to when such regions are provided inside the coil, leakage of magnetic flux to the outside of the multilayer coil component is reduced. As a result, a high inductance can be achieved in the multilayer coil component.

Preferably, the low-magnetic-permeability layer has a rectangular or substantially rectangular shape, and the holes or the recesses are provided in the proximity of longer sides of the low-magnetic-permeability layer. The distance from the center of the coil to the longer sides of the low-magnetic-permeability layer is less than the distance from the center of the coil to the shorter sides of the low-magnetic-permeability layer. Therefore, a magnetic flux generated by the coil tends to leak more from the longer sides than from the shorter sides. Thus, the holes or the recesses are provided in the proximity of the low-magnetic-permeability layer so that magnetic resistance in the proximity of the longer sides is reduced. Accordingly, leakage of magnetic flux is effectively reduced, so that the inductance of the multilayer coil component can be increased.

Preferably, the low-magnetic-permeability layer has a rectangular or substantially rectangular shape, external electrodes are provided, the external electrodes being provided on surfaces of a multilayer block formed by stacking the magnetic layers and the low-magnetic-permeability layer, and the external electrodes being electrically connected to the coil, the holes or the recesses are provided in the proximity of either longer sides or shorter sides of the low-magnetic-permeability layer, and the external electrodes are provided on side surfaces of the multilayer block, the side surfaces including sides of the low-magnetic-permeability layer that are different from the sides of the low-magnetic-permeability layer along which the holes or the recesses are provided. Furthermore, preferably, the holes or the recesses are provided in the proximity of the longer sides of the low-magnetic-permeability layer, and the external electrodes are provided on side surfaces of the multilayer block including the shorter sides of the low-magnetic-permeability layer. By providing the holes or recesses or the external electrodes in the proximity of the individual sides as described above, leakage of magnetic flux from the side surfaces of the multilayer block is effectively suppressed. As a result, the inductance of the multilayer coil component can be increased.

In the multilayer coil component according to this preferred embodiment of the present invention, the low-magnetic-permeability layer may be made of a non-magnetic material.

The multilayer coil component according to preferred embodiments of the present invention can be manufactured by the following manufacturing method. Specifically, a method of manufacturing a multilayer coil component including a multilayer block having a coil therein includes a step of forming magnetic layers and a low-magnetic-permeability layer having a lower magnetic permeability than the magnetic layers, a step of forming coil conductors in main surfaces of the magnetic layers, a step of forming holes or recesses in a main surface of the low-magnetic-permeability layer, and a step of forming a multilayer block in which the magnetic layers are in contact with inner peripheral surfaces of the holes or the recesses by stacking the magnetic layers and the low-magnetic-permeability layer so that the low-magnetic-permeability layer is disposed between the magnetic layers. According to the manufacturing method, the multilayer coil component can be effectively manufactured.

According to preferred embodiments of the present invention, an anchoring effect is provided between the low-magnetic-permeability layer and the magnetic layers. Thus, the occurrence of cracks or delamination between the magnetic layers and the low-magnetic-permeability layer is suppressed.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view of a multilayer coil component according to a preferred embodiment of the present invention.

FIG. 2 is an external perspective view of the multilayer coil component.

FIG. 3 is a diagram showing a sectional structure of the multilayer coil component.

FIG. 4 is an exploded perspective view according to a first modification of the multilayer coil component according to preferred embodiments of the present invention.

FIG. 5 is a diagram showing a sectional structure according to the first modification of the multilayer coil component.

FIG. 6 is an exploded perspective view according to a second modification of the multilayer coil component according to preferred embodiments of the present invention.

FIG. 7 is a diagram showing a sectional structure according to a third modification of the multilayer coil component according to preferred embodiments of the present invention.

FIG. 8 is a diagram showing a sectional structure according to a fourth modification of the multilayer coil component according to preferred embodiments of the present invention.

FIG. 9 is a diagram showing a sectional structure according to a fifth modification of the multilayer coil component according to preferred embodiments of the present invention.

FIG. 10 is a diagram showing a sectional structure according to a sixth modification of the multilayer coil component according to preferred embodiments of the present invention.

FIG. 11 is a diagram for explaining an advantage of a modification of the multilayer coil component according to preferred embodiments of the present invention.

### DETAILED DESCRIPTION OF THE PREFERRED EMBODIMENTS

Preferred embodiments of an open-magnetic-circuit multilayer coil component and a method of manufacturing the same according to the present invention will be described with reference to the drawings. The present preferred embodiment deals with an example of an individually manufactured product. With mass production, a large number of internal conductor patterns are printed on the surface of a mother green ceramic sheet, and a plurality of such mother green ceramic sheets are stacked and pressure-bonded to form an unfired multilayer block. Then, the multilayer block is cut in accordance with the layout of the internal conductor patterns to cut out individual multilayer ceramic chips, the multilayer ceramic chips that have been cut out are fired, and external electrodes are formed on the fired multilayer ceramic chips, whereby multilayer coil components are manufactured. Alternatively, it is possible to stack and pressure-bond mother green ceramic sheets, fire the mother green ceramic sheets, and then cut out individual multilayer ceramic chips.

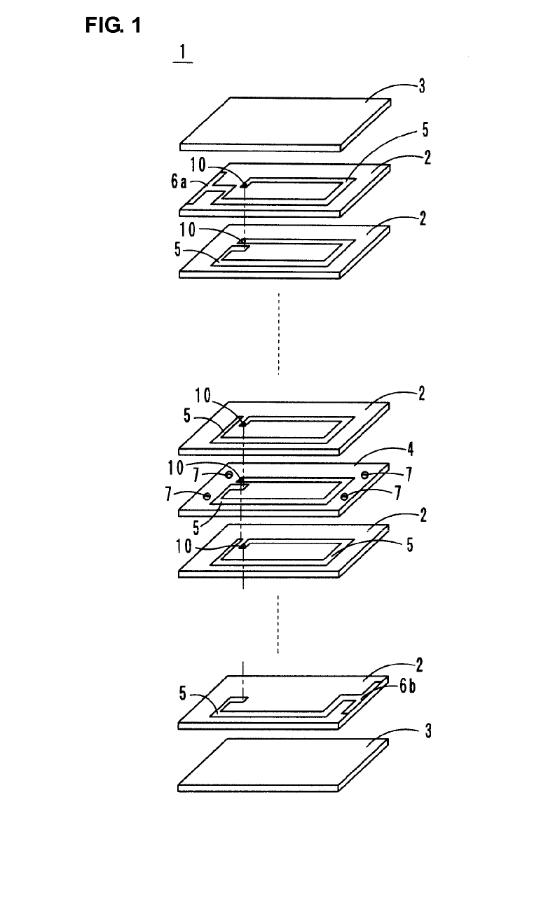

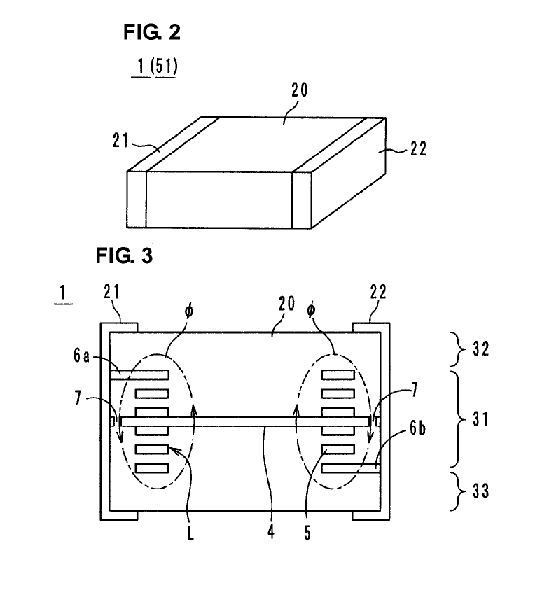

FIG. 1 is an exploded perspective view of a multilayer coil component 1. FIG. 2 is an external perspective view of the multilayer coil component 1. FIG. 3 is a diagram showing a sectional structure of the multilayer coil component 1.

As shown in FIG. 1, the multilayer coil component 1 includes first ceramic sheets 2, second ceramic sheets 3, and a third ceramic sheet 4.

The first ceramic sheets 2 are made of a magnetic material, and coil conductor patterns 5 and via-hole conductors 10 are provided in main surfaces thereof. The second ceramic sheets 3 are made of a magnetic material similar to the first ceramic sheets 2, but coil conductor patterns 5 are not provided in main surfaces thereof. The third ceramic sheet 4 is made of a low-magnetic-permeability material or a non-magnetic material (having a magnetic permeability of 1), and a coil conductor pattern 5, a via-hole conductor 10, and a hole 7 are provided in a main surface thereof.

The first ceramic sheets 2 and the second ceramic sheets 3 are manufactured in the following manner. Materials of ferric oxide (Fe₂O₃), zinc oxide (ZnO), nickel oxide (NiO), and copper oxide (CuO) weighed according to a predetermined ratio are disposed in a ball mill as raw materials, and wet blending is performed. The resulting mixture is dried and then ground, and the resulting powder is calcined for about one hour at about 750° C. The resulting calcined powder is wet-ground in the ball mill, and dried and disintegrated, whereby ferrite ceramic powder is obtained.

A binder, a plasticizer, a wetting agent, and a dispersant are added to the ferrite ceramic powder and mixed in the ball mill, and then degassing is performed by decompression. Using a doctor blade method, the resulting ceramic slurry is formed into sheets and dried, whereby green first ceramic sheets 2 and green second ceramic sheets 3 having desired thicknesses are manufactured.

The third ceramic sheet 4 is manufactured in the following manner. Materials of ferric oxide (Fe₂O₃), zinc oxide (ZnO), and copper oxide (CuO) weighed according to a predetermined ratio are disposed in a ball mill as raw materials, and wet blending is performed. The resulting mixture is dried and then ground, and the resulting powder is calcined for about one hour at about 750° C. The resulting calcined powder is wet-ground in the ball mill, and dried and then disintegrated, whereby non-magnetic ceramic powder is obtained.

A binder, a plasticizer, a wetting agent, and a dispersant are added to the non-magnetic ceramic powder and mixed in the ball mill, and then degassing is performed by decompression. Using a doctor blade method, the resulting ceramic slurry is formed into a sheet and dried, whereby a third green third ceramic sheet 4 having a desired thickness is manufactured. The thickness of the third ceramic sheet 4 is, for example, about 20 μm.

On the first ceramic sheets 2 and the third ceramic sheet 4, via-hole conductors 10 connecting the coil conductor patterns 5 of adjacent layers to each other are formed. The via-hole conductors 10 are formed by forming through holes in the first ceramic sheets 2 and the third ceramic sheet 4 using laser beams or other suitable method, and filling the through holes with conductive paste of Ag, Pd, Cu, Au, an alloy of these metals, or other suitable conductive paste, by print coating or other suitable method.

On the first ceramic sheets 2 and the third ceramic sheet 4, coil conductor patterns 5 are formed individually by applying conductive paste by screen printing, photolithography or other suitable method. These conductor patterns 5 are made of Ag, Pd, Cu, Au, an alloy of these metals, or other suitable conductive paste.

In a main surface of the third ceramic sheet 4, as shown in FIG. 1, holes 7 that penetrate into the main surface of the third ceramic sheet 4 in a stacking direction are formed. Preferably, the holes 7 are formed in regions outside the coil conductor pattern 5 when viewed in the stacking direction. Furthermore, more preferably, of the regions outside the coil conductor pattern 5, the holes 7 are formed particularly in the proximity of the periphery of the third ceramic sheet 4. In this preferred embodiment, the holes 7 are formed in the proximity of the shorter sides of the third ceramic sheet 4. The holes 7 may be formed by press-processing the third ceramic sheet 4 using a die having projected portions formed thereon, or by punching the third ceramic sheet 4 using a laser.

The plurality of coil conductor patterns 5 are electrically connected in series via the via-holes 10 formed on the first ceramic sheets 2 and the third ceramic sheet 4, thereby forming a coil L having a spiral shape. The coil axis of the coil L is parallel to the stacking direction of the second ceramic sheets 3 and the third ceramic sheet 4. Leads 6a and 6b of the coil L are exposed respectively on the left side of first ceramic sheet 2 disposed at an uppermost layer and the right side of the first ceramic sheet 2 disposed at a lowermost layer among the plurality of first ceramic sheets 2.

As shown in FIG. 1, the first ceramic sheets 2 are stacked above and below the third ceramic sheet 4 so that the third ceramic sheet 4 is disposed therebetween, and the second ceramic sheets 3 are stacked above and below the third ceramic sheet 4. At this time, the third ceramic sheet 4 is stacked so as to be located substantially at the center in a length direction of the coil L. The first ceramic sheets 2, second ceramic sheets 3, and third ceramic sheet 4 are pressed from above and below. At the time of the pressing, portions of the first ceramic sheets 2 adjacent to the third ceramic sheet 4 enter the holes 7. Thus, the first ceramic sheets 2 adjacent to the third ceramic sheet 4 come into contact with inner peripheral surfaces of the holes 7. In this manner, an unfired multilayer block is formed.

Then, the unfired multilayer block is fired in its entirety, whereby a multilayer block 20 having a substantially rectangular parallelepiped shape as shown in FIG. 2 is formed. On surfaces of the multilayer block 20, input/output external electrodes 21 and 22 are formed. Preferably, the input/output external electrodes 21 and 22 are formed on side surfaces of the substantially rectangular parallelepiped located on shorter sides of the third ceramic sheet 4. Thus, in this preferred embodiment, the input/output external electrodes 21 and 22 are preferably formed on left and right end surfaces of the multilayer block 20, as shown in FIG. 2. The leads 6a and 6b of the coil L are electrically connected to the input/output external electrodes 21 and 22.

The multilayer coil component 1 obtained in this manner includes a coil section 31 including the coil L formed by electrically connecting the plurality of coil conductor patterns 5, and outer layer sections 32 and 33 stacked in regions above and below the coil section 31. Furthermore, in the stacking direction of the multilayer coil component 1, the third ceramic sheet 4 is disposed substantially at the center of the coil section 31. Thus, a magnetic flux Φ generated by the coil L passes through an open magnetic circuit formed by the third ceramic sheet 4.

As described above, in the multilayer coil component 1, the first ceramic sheets 2 above and below the third ceramic sheet 4 are in contact with the inner peripheral surfaces of the holes 7. Thus, an anchoring effect is provided between the first ceramic sheets 2 and the third ceramic sheet 4. This suppresses the occurrence of cracks or delamination between the first ceramic sheets 2 and the ceramic sheet 4.

Furthermore, in the multilayer coil component 1, the holes 7 are provided in the proximity of the shorter sides of the third ceramic sheet 4. In regions in the proximity of the periphery of the third ceramic sheet 4, such as the shorter sides, cracks or delamination tends to occur during firing of the multilayer block 20 due to warpage of stacked ceramic sheets. Thus, by forming the holes 7 in the proximity of the periphery of the third ceramic sheet 4 as in the multilayer coil component 1 so as to improve the binding force between the first ceramic sheets 2 and the third ceramic sheet 4 in the proximity of the periphery, the occurrence of cracks or delamination is effectively suppressed.

Furthermore, in the multilayer coil component 1, the inductance of an open-magnetic-circuit multilayer coil component can be readily increased. The reason for this will be described below.

In order to increase the inductance in an open-magnetic-circuit multilayer coil component, the magnetic resistance of the magnetic circuit must be reduced by forming the third ceramic sheet 4 with a small thickness. However, the amount by which the thickness of the third ceramic sheet 4 can be reduced is limited. Thus, in the multilayer coil component 1, the holes 7 are formed in the third ceramic sheet 4 and portions of the first ceramic sheets 2 are caused to enter the holes 7 so that the magnetic resistance of the magnetic circuit is reduced. It is easier to form the holes 7 as described above than to form the third ceramic sheet 4 with a very small thickness. Therefore, in the multilayer coil component 1, it is readily possible to increase the inductance as compared to an existing open-magnetic-circuit multilayer coil component.

Furthermore, in the multilayer coil component 1, the holes 7 are provided in the proximity of the shorter sides of the third ceramic sheet 4. By forming the holes 7 in the proximity of the periphery of the third ceramic sheet 4 as described above, such as the shorter sides, as compared to when the holes 7 are formed inside the coil L, the magnetic circuit outside the coil L is similar to a closed magnetic circuit. As a result, leakage of magnetic flux outside of the multilayer coil component 1 is suppressed, so that the inductance of the multilayer coil component 1 can be effectively increased.

Furthermore, in the multilayer coil component 1, it is possible to improve the frequency characteristics and to thereby reduce power loss at high frequencies while maintaining a large inductance. This will be described below.

In an existing open-magnetic-circuit multilayer coil component, in order to increase inductance, a material having a large magnetic permeability (ferrite) is used for the third ceramic sheet 4. Generally, materials having a large magnetic permeability cause large power loss at high frequencies. Thus, in order to achieve both a large inductance and a reduced power loss at high frequencies, the third ceramic sheet 4 must have a minimum thickness.

However, as described earlier, there is a limit to the amount that the thickness of the third ceramic sheet 4 can be reduced. Thus, in the multilayer coil component 1, the third ceramic sheets 4 have a relatively large thickness using a material having a relatively small magnetic permeability, and portions of the first ceramic sheets 2 are caused to enter the holes 7 provided in the third ceramic sheet 4. As previously described, it is easier to form the holes 7 in the third ceramic sheet 4 and to cause portions of the first ceramic sheets 2 to enter the holes 7 than to form the third ceramic sheet 4 with a small thickness. Thus, it is possible to both reduce the power loss at high frequencies and increase the inductance using a relatively simple method.

Furthermore, in the multilayer coil component 1, it is possible to control the DC superposing characteristics. As the size or number of the holes 7 of the multilayer coil component 1 changes, the DC superposing characteristics also change. More specifically, if the size of the holes 7 is increased, the magnetic resistance of the magnetic circuit is decreased, so that magnetic saturation tends to occur and DC superposing characteristics deteriorate. On the other hand, if the size of the holes 7 is decreased, the magnetic resistance of the magnetic circuit is increased, so that magnetic saturation does not tend to occur and DC superposing characteristics are improved. Therefore, in the multilayer coil component 1, it is possible to control the DC superposing characteristics by adjusting the size of the holes 7.

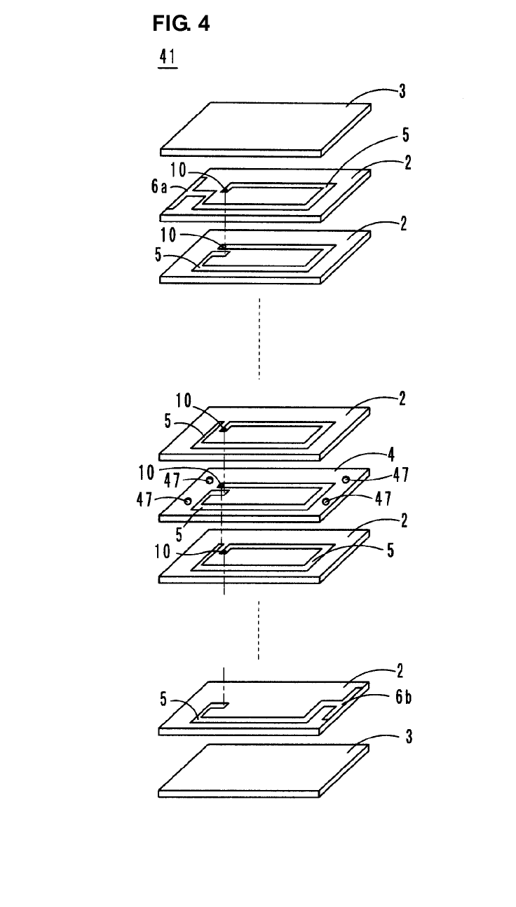

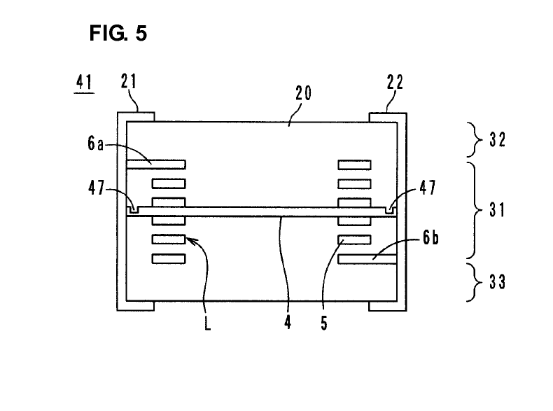

As shown in FIGS. 4 and 5, recesses 47 may be provided on the third ceramic sheet 4 instead of the holes 7. FIG. 4 is an exploded perspective view of a multilayer coil component 41. FIG. 5 is a diagram showing a cross-section of the structure of the multilayer coil component 41.

More specifically, in the main surface of the third ceramic sheet 4, recesses 47 are provided such that the main surface of the third ceramic sheet 4 is recessed in the stacking direction, as shown in FIGS. 4 and 5. Similar to the holes 7, the recesses 47 are provided in the proximity of the shorter sides of the third ceramic sheet 4. The recesses 47 are formed by press-processing the third ceramic sheet 4 using a die having projected portions provided thereon.

Alternatively, the holes 7 or the recesses 47 may be formed in the proximity of the longer sides of the third ceramic sheet 4 instead of in the proximity of the shorter sides thereof.

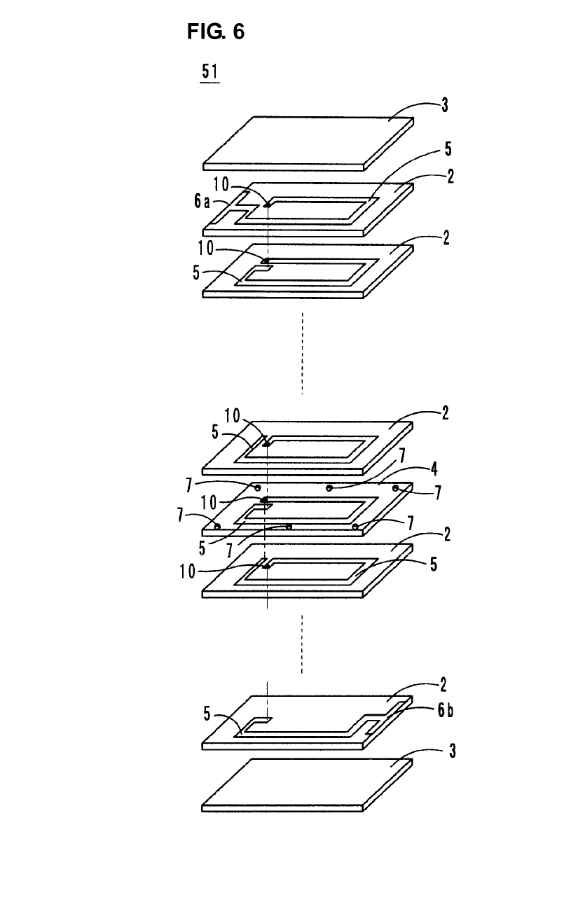

More specifically, in the main surface of the third ceramic sheet 4, holes 7 penetrating the main surface of the third ceramic sheet 4 in the stacking direction are provided, as shown in FIG. 6. As opposed to the holes 7 of the multilayer coil component 1, the holes 7 of a multilayer coil component 51 are provided in the proximity of the longer sides of the third ceramic sheet 4.

According to the multilayer coil component 51 described above, since the holes 7 are provided in the proximity of the longer sides of the third ceramic sheet 4, as compared to the multilayer coil component 1, the inductance of an open-magnetic-circuit multilayer coil component can be more effectively increased. The reason for this will be described below.

In the multilayer coil component 51 formed by stacking the rectangular third ceramic sheet 4, shown in FIG. 6, the longer sides of the third ceramic sheet 4 have a shorter distance from the center of the coil L and have a longer length of contact with the outside as compared to the shorter sides thereof. Thus, magnetic flux leaks to a greater extent from the longer sides of the third ceramic sheet 4 than from the shorter sides of the third ceramic sheet 4. Thus, the holes 7 are provided in the proximity of the longer sides of the third ceramic sheet 4 as shown in FIG. 6, so that portions of the first ceramic sheets 2 enter the holes 7, whereby magnetic resistance at the holes 7 is reduced. As a result, magnetic flux that leaks around the holes 7 is reduced, so that leakage of magnetic flux to the outside of the multilayer coil component 51 is reduced. Thereby, the inductance of the multilayer coil component 51 can be increased.

Furthermore, when the holes 7 are provided in the proximity of the longer sides of the third ceramic sheet 4 as shown in FIG. 6, preferably, the input/output external electrodes 21 and 22 are provided on side surfaces of the multilayer block 20 including the shorter sides of the third ceramic sheet 4. That is, preferably, the sides included in the side surfaces on which the input/output external electrodes 21 and 22 are provided are different from the sides of the third ceramic sheet 4 at which the holes 7 are provided. Thus, leakage of magnetic flux is suppressed in the proximity of the shorter sides of the third ceramic sheet 4 by eddy currents generated by the input/output external electrodes, and leakage of magnetic flux is suppressed in the proximity of the longer sides of the third ceramic sheet 4 by the holes 7, so that leakage of magnetic flux is efficiently suppressed in the proximity of each side. As a result, the inductance of the multilayer coil component 51 can be more effectively increased.

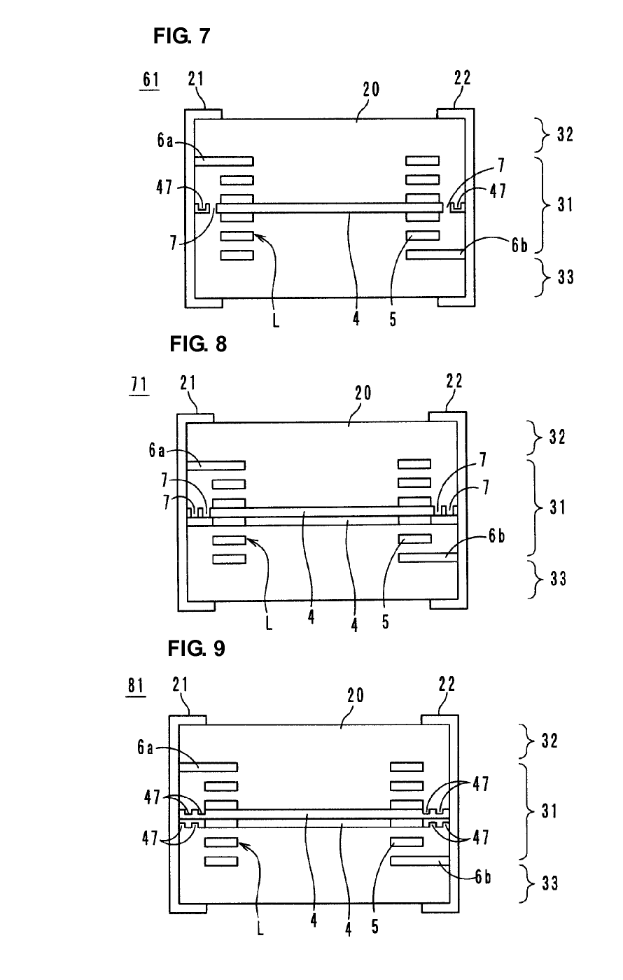

Furthermore, the holes 7 and the recesses 47 may be provided in combination in the third ceramic sheet 4, as shown in FIG. 7.

Furthermore, instead of using only one third ceramic sheet 4, a plurality of third ceramic sheets 4 may be provided. By providing a plurality of third ceramic sheets 4, DC superposing characteristics are improved. In this case, it is possible to provide the holes 7 only in either one of the third ceramic sheets 4, as shown in FIG. 8. Furthermore, the locations of the recesses 47 provided in the third ceramic sheet 4 in an upper layer and the locations of the recesses 47 provided in the third ceramic sheet 4 in a lower layer may be shifted with respect to each other in a horizontal direction, as shown in FIG. 9.

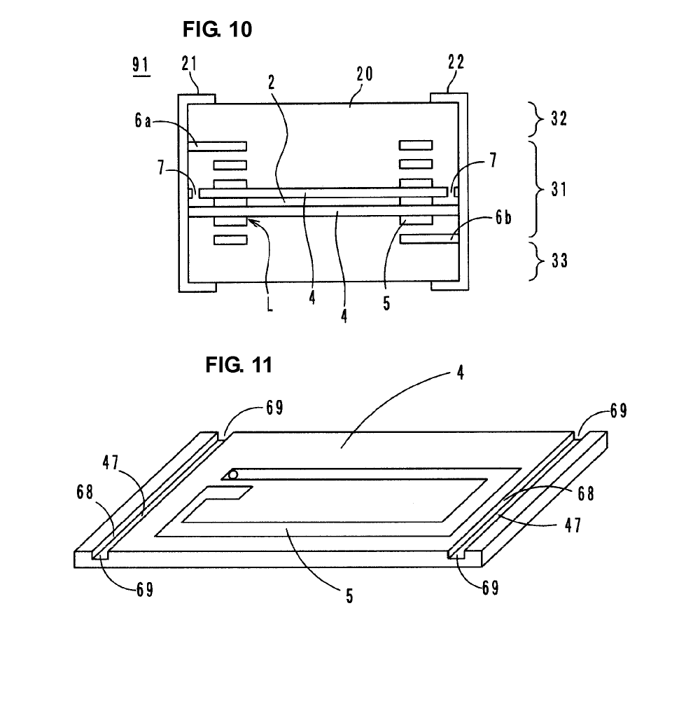

Furthermore, the plurality of third ceramic sheets 4 may be disposed separately from each other with the first ceramic sheets 2 disposed therebetween, as shown in FIG. 10.

Furthermore, the recesses 47 may have the shape of grooves such that the side surface on the front side and the side surface on the rear side are connected in the proximity of the shorter sides of the third ceramic sheet 4. That is, side surfaces 68 that define the inner peripheral surfaces of the holes 7 or the recesses 47 are not required to be continuously connected to each other. In this case, however, end openings 69, such as recesses 47, are provided at the ends of the third ceramic sheet 4. Since the first ceramic sheets 2 and the third ceramic sheet 4 do not come into contact at the end openings 69, a sufficient anchoring effect is not achieved between the first ceramic sheets 2 and the third ceramic sheet 4. Thus, preferably, the side surfaces 68 that define the inner peripheral surfaces of the recesses 47 are continuously connected to each other.

Furthermore, the third ceramic sheet 4 may be disposed at a location that is different from a substantial center in the length direction of the coil L.

Furthermore, although the sectional shapes of the holes 7 and the recesses 47 are assumed to be circular or substantially circular in FIG. 1 and so forth, the sectional shapes are not limited to circular or substantially circular shapes. Thus, for example, the sectional shapes may be rectangular or substantially rectangular shapes.

Furthermore, the degree to which portions of the first ceramic sheets 2 enter the holes 7 or the recesses 47 may be such that the first ceramic sheets 2 are in contact with side surfaces that define the inner peripheral surfaces of the holes 7 or the recesses 47. Thus, the holes 7 or the recesses 47 need not necessarily be filled with portions of the first ceramic sheets 2.

Furthermore, the holes 7 or the recesses 47 may be provided both in the proximity of the longer sides and in the proximity of the shorter sides of the third ceramic sheet 4.

As described above, the present invention is useful for multilayer coil components and methods of manufacturing the same, and is particularly advantageous in that cracks or delamination between layers having different magnetic permeabilities do not occur.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A multilayer coil component comprising:
a coil including stacked magnetic layers and a low-magnetic-permeability layer, the magnetic layers having coil conductors provided therein, the low-magnetic-permeability layer having a lower magnetic permeability than that of the magnetic layers, and the coil conductors being electrically connected to each other; wherein
the low-magnetic-permeability layer is disposed between the magnetic layers;
at least one of holes and recesses are provided in a main surface of the low-magnetic-permeability layer; and
the magnetic layers adjacent to the low-magnetic-permeability layer are in contact with inner peripheral surfaces of the at least one of the holes and the recesses.

2. The multilayer coil component according to claim 1, wherein the low-magnetic-permeability layer includes a coil conductor provided therein.

3. The multilayer coil component according to claim 1, wherein side surfaces that define the inner peripheral surfaces of the at least one of the holes and the recesses are continuously connected to each other.

4. The multilayer coil component according to claim 1, wherein the at least one of the holes and the recesses are provided in regions outside the coil when viewed in a stacking direction.

5. The multilayer coil component according to claim 1, wherein the at least one of the holes and the recesses are provided in the proximity of a periphery of the low-magnetic-permeability layer.

6. The multilayer coil component according to claim 1, wherein
the low-magnetic-permeability layer has a substantially rectangular shape; and
the at least one of the holes and the recesses are provided in the proximity of longer sides of the low-magnetic-permeability layer.

7. The multilayer coil component according to claim 1, wherein
the low-magnetic-permeability layer has a substantially rectangular shape;
external electrodes are provided on surfaces of a multilayer block, the external electrodes being electrically connected to the coil;
the at least one of the holes and the recesses are provided in the proximity of either longer sides or shorter sides of the low-magnetic-permeability layer; and
the external electrodes are provided on side surfaces of the multilayer block, the side surfaces including the sides of the low-magnetic-permeability layer that are different from the sides of the low-magnetic-permeability layer at which the at least one of the holes and the recesses are provided.

8. The multilayer coil component according to claim 7, wherein
the at least one of the holes and the recesses are provided in the proximity of the longer sides of the low-magnetic-permeability layer; and
the external electrodes are provided on side surfaces of the multilayer block including the shorter sides of the low-magnetic-permeability layer.

9. The multilayer coil component according to claim 1, wherein the low-magnetic-permeability layer is made of a non-magnetic material.

10. A method of manufacturing a multilayer coil component including a multilayer block including a coil therein, the method comprising:
a step of forming magnetic layers and a low-magnetic-permeability layer having a lower magnetic permeability than that of the magnetic layers;
a step of forming coil conductors in main surfaces of the magnetic layers;
a step of forming at least one of holes and recesses in a main surface of the low-magnetic-permeability layer; and
a step of forming a multilayer block in which the magnetic layers are in contact with inner peripheral surfaces of the at least one of the holes and the recesses by stacking the magnetic layers and the low-magnetic-permeability layer so that the low-magnetic-permeability layer is disposed between the magnetic layers.
